(19) United States
(12) Patent Application Publication
(10) Pub. No.: US 2011/0242436 A1
(43) Pub. Date: Oct. 6, 2011

(54) REAR PROJECTION SYSTEM

(76) Inventors: Andrew Olcott, Newtonville, MA (US); Lee Zamir, Cambridge, MA (US)

(21) Appl. No.: 12/751,898

(22) Filed: Mar. 31, 2010

(51) Int. Cl. H04N 5/64; H04N 3/26

(52) U.S. Cl. 348/745; 348/789; 348/E05.128; 348/E03.048

(57) ABSTRACT

The present disclosure generally relates to a rear projection system. The rear projection system may include a housing assembly configured to house at least a portion of a speaker system. The housing assembly may include a multi-function panel that is at least partially optically transmissive and includes an acoustically transparent portion. The rear projection system may further include a rear projection device positioned within the housing assembly and configured to project a graphical user interface onto an interior surface of the acoustically transparent portion of the multi-function panel. Other embodiments are also within the scope of the present disclosure.

### TECHNICAL FIELD

This disclosure generally relates to a system for rear projection. More specifically, the present disclosure relates to a rear projection system configured to display a graphical user interface associated with e.g., an audio or speaker system.

### BACKGROUND

Some audio systems include various displays or graphical user interfaces (GUIs) configured to provide information to the consumer. In the past, these displays may have been implemented as thin film transistor liquid crystal displays (TFT-LCD), segmented LCDs, organic light emitting diodes (OLED), vacuum florescent displays (VFD), cathode ray tube (CRT) and other suitable technologies. Unfortunately, these technologies often limit the display to flat surfaces. These technologies also often add unnecessary costs to the system by requiring expensive materials and/or increasing engineering requirements. Further, many of these materials, if associated with a speaker system, may negatively affect sound quality as the materials in these displays are acoustically opaque.

### SUMMARY OF DISCLOSURE

According to the present disclosure, a rear projection system is provided. The rear projection system may include a housing assembly configured to house at least a portion of a speaker system. The housing assembly may include a multi-function panel, wherein the multi-function panel is at least partially optically transmissive and includes an acoustically transparent portion. The rear projection system may further include a rear projection device positioned within the housing assembly and configured to project a graphical user interface onto an interior surface of the acoustically transparent portion of the multi-function panel.

One or more of the following features may be included. In some embodiments, the rear projection system may also include an audio system positioned within the housing assembly and configured to provide an audio signal for rendering on the speaker system, wherein the audio system provides information for inclusion within the graphical user interface.

In some embodiments, the rear projection system may further include a docking port configured to releasably engage an audio device and configured to provide an audio signal for rendering on the speaker system, wherein the audio device provides information for inclusion within the graphical user interface.

In some embodiments, the acoustically transparent portion of the multi-function panel may include a quasi-acoustically transparent material. The multi-function panel may also include a control surface portion. The multi-function panel may be planar and/or non-planar.

In some embodiments, the rear projection device may include a pico-projector. The pico-projector may be a scanned laser pico-projector. The rear projection system may further include one or more reflective devices positioned within the housing, the one or more reflective devices configured to guide the graphical user interface from the rear projection device to the interior surface of the multi-function panel. At least one of the one or more reflective devices may include a curved mirror.

In another embodiment of the present disclosure, a rear projection system is provided. The rear projection system may include a housing assembly configured to house at least a portion of a speaker system. The housing assembly may include a multi-function panel, wherein the multi-function panel is at least partially optically transmissive and includes an acoustically transparent portion. The rear projection system may also include a rear projection device positioned within the housing assembly and configured to project a graphical user interface onto an interior surface of the acoustically transparent portion of the multi-function panel. The rear projection system may further include an audio system positioned within the housing assembly and configured to provide an audio signal for rendering on the speaker system, wherein the audio system provides information for inclusion within the graphical user interface.

One or more of the following features may be included. The multi-function panel may include a control surface portion. In some embodiments, the rear projection device may be a pico-projector. The pico-projector may be a scanned laser pico-projector.

In another embodiment of the present disclosure, a rear projection system is provided. The rear projection system may include a housing assembly configured to house at least a portion of a speaker system. The housing assembly may include a multi-function panel, wherein the multi-function panel is at least partially optically transmissive and includes an acoustically transparent portion. The rear projection system may further include a rear projection device positioned within the housing assembly and configured to project a graphical user interface onto an interior surface of the acoustically transparent portion of the multi-function panel. The rear projection system may also include a docking port configured to releasably engage an audio system and configured to provide an audio signal for rendering on the speaker system, wherein the audio system provides information for inclusion within the graphical user interface.

One or more of the following features may be included. The multi-function panel may include a control surface portion. In some embodiments, the rear projection device may be a pico-projector. The pico-projector may be a scanned laser pico-projector.

The details of one or more implementations are set forth in the accompanying drawings and the description below. Other features and advantages will become apparent from the description, the drawings, and the claims.

### BRIEF DESCRIPTION OF THE DRAWINGS

FIG. 1 depicts a cross-sectional view of an embodiment of a rear projection system in accordance with the present disclosure;

FIG. 2 depicts a perspective view of an embodiment of a rear projection system in accordance with the present disclosure;

FIG. 3 depicts a front view of an embodiment of a rear projection system in accordance with the present disclosure;

FIG. 4 depicts a perspective view of an embodiment of a rear projection system in accordance with the present disclosure; and

FIG. 5 depicts a perspective view of an embodiment of a rear projection system in accordance with the present disclosure.

Like reference symbols in the various drawings indicate like elements.

### DETAILED DESCRIPTION OF THE PREFERRED EMBODIMENTS

The present disclosure generally relates to a rear projection system. Embodiments of the present disclosure provide a rear projection system having a projection device included within a housing assembly. The housing assembly may be associated with an audio/speaker system such as those available from the Bose® Corporation of Framingham, Mass. The rear projection system may also include a multi-function panel having an acoustically transparent portion. The multi-function panel may be configured to display a graphical user interface on a variety of different surfaces, e.g., planar, non-planar, etc.

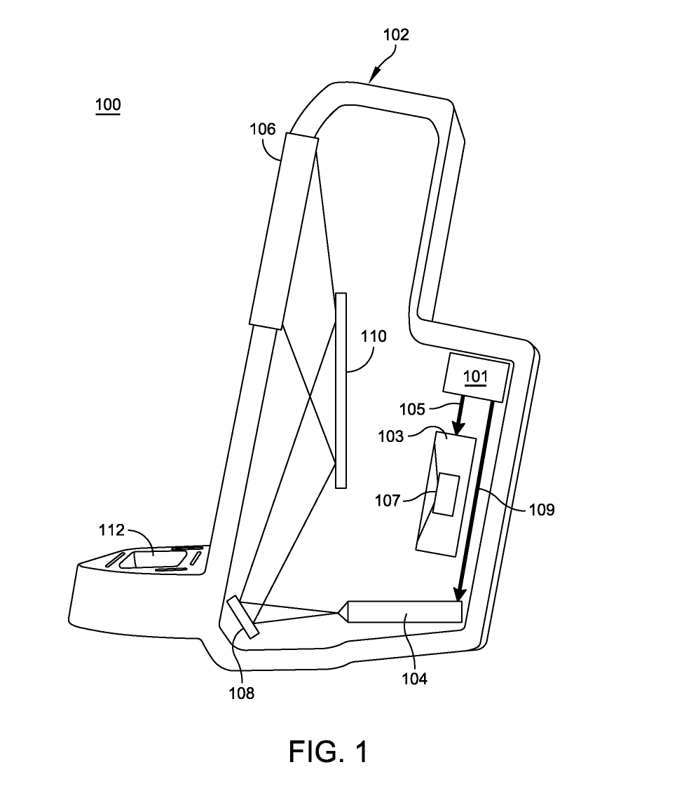

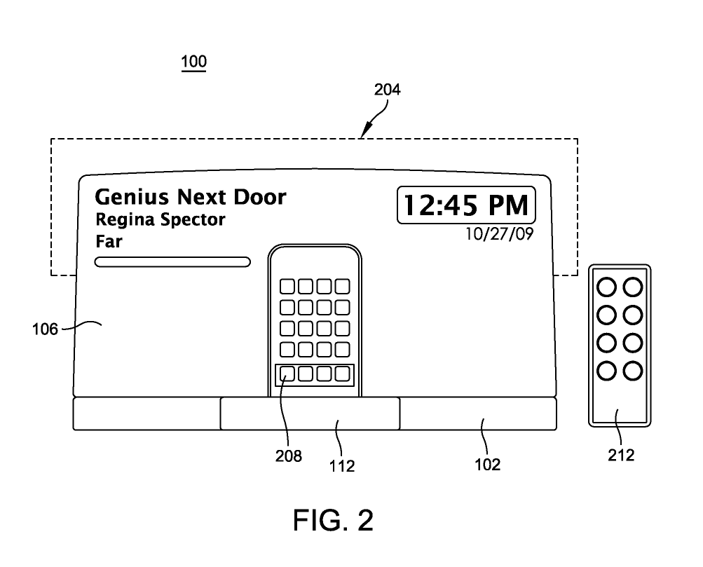

Referring now to FIGS. 1-2, an embodiment of the present disclosure depicting rear projection system 100 is provided. Rear projection system 100 may include housing assembly 102 having rear projection device 104 positioned therein.

In some embodiments, housing assembly 102 may form a substantially hollow enclosure as shown cross-sectionally in FIG. 1. Housing assembly 102 may include at least a portion of a speaker system, which may be configured to generate sound using traditional audio speaker transducer technologies (or other suitable methods) and to transmit the generated sound through multi-function panel 106. Housing assembly 102 may further include additional components, including, but not limited to, acoustic waveguide structures (not shown), passive radiators (not shown), acoustic insulators (not shown), acoustic dampening material (not shown) and/or any other features that may improve the acoustic performance of an audio speaker system. Examples of such audio speaker systems may include, but are not limited to, those associated with the Wave® Music System and SoundDock® speaker systems available from the Bose Corporation, Framingham, Mass.

In some embodiments, portions of housing assembly 102 may be constructed out of one or more rigid materials, examples of which may include, but are not limited to, polymeric, ceramic, and metallic materials. These materials may be selected to provide the requisite level of rigidity required to minimize any vibrations caused by the speaker assembly.

In some embodiments, rear projection device 104 may be operatively coupled with an audio system and/or audio device (as will be discussed in further detail below). Rear projection device 104 may receive one or more control signals and may be configured to project a graphical user interface onto an interior and/or exterior portion of multi-function panel 106. Rear projection device 104 may be secured and positioned within housing assembly 102 in a variety of suitable positions. In this way, rear projection device 104 may be configured to project light partially and/or entirely within housing assembly 102 and onto multi-function panel 106.

Rear projection device 104 may be any suitable projecting device, examples of which may include, but are not limited to, scanned laser pico-projectors such as those available from Microvision of Redmond, Wash. and DLP-based pico-projectors such as those available from Optoma USA of Milpitas, Calif. The small form-factor associated with the pico-projector may allow for minimal product depth in housing assembly 102.

In some embodiments, rear projection device 104 may project light onto one or more reflective devices (e.g., reflective devices 108, 110) positioned within housing assembly 102. Reflective devices 108, 110 may be configured to guide the light corresponding to the graphical user interface from rear projection device 104 to an exterior and/or interior surface of multi-function panel 106. Reflective devices 108, 110 may be configured in a variety of different arrangements and constructed out of a variety of different materials. For example, reflective devices 108, 110 may be flat or curved mirrors, which may be secured to portions of housing assembly 102. In this way, reflective devices 108, 110 may be configured to lengthen the path of projected light in order to create large graphical user interfaces while maintaining a minimal product depth. Additionally/alternatively, the shape of reflective devices 108, 110 may be varied to focus the graphical user interface as it is guided onto multi-function panel 106.

Reflective devices 108 and 110 may be secured using any suitable method. For example, rigid extension members (not shown) may be affixed to an interior portion of housing assembly 102. The extension member (not shown) may also include the reflective device secured thereto. Numerous other arrangements are also within the scope of the present disclosure, some of which may include, but are not limited to cable assemblies, bracket/rod type assemblies, use of adhesives, heat bonding, ultrasonic welding, etc.

In some embodiments, and as discussed above, housing assembly 102 may include multi-function panel 106. The term “panel”, as used herein, is meant to refer to one or more rigid or non-rigid surfaces configured to display a graphical user interface. For example, multi-function panel 106 may include speaker grill components, speaker cloth components, combination grill/cloth arrangements, rigid plastic components, etc. Multi-function panel 106 may be planar, non-planar, partially planar, and/or partially non-planar.

Multi-function panel 106 may be configured to receive the graphical user interface from rear projection device 104 and to display the graphical user interface on an interior and/or exterior surface of multi-function panel 106, thus allowing the graphical user interface to be viewable from the exterior of housing assembly 102. In this way, multi-function panel 106 may be at least partially optically transmissive, thus allowing for some or all of the light from rear projection device 104 to pass therethrough and making at least a portion of the graphical user interface viewable from the outside of the housing assembly 102. Multi-function panel 106 may include interior and exterior surfaces, which may be constructed out of a variety of different materials. For example, in some embodiments, the exterior surface of multi-function panel 106 may be constructed out of either a hard or soft material. As discussed above, all or a portion of multi-function panel 106 may include speaker grill assemblies. As is know in the art, speaker grill assemblies may be constructed from either hard grill material or soft grill material. Examples of such soft grill material may include, but are not limited to, cloth, weaving, stitching, foam, fabric upholsteries and other suitable materials. Examples of such hard grill material may include, but are not limited to, metal, wood and/or plastic materials. As is known in the art, some solid grills may be constructed from a sheet of material that include a plurality of holes through which sound may pass, while others may be constructed with thin strips of material either crosshatched together or equally spaced in parallel. Multi-function panel 106 may be constructed entirely out of soft speaker grill materials, hard speaker grill materials, or a hybrid combination. As discussed above, multi-function panel 106 may further include one or more rigid plastic components.

In some embodiments, multi-function panel 106 may include both an acoustically transparent portion and a control surface portion (e.g., the above-stated rigid plastic components) as discussed in further detail below. The phrase “acoustically transparent”, as used herein, is meant to refer to a material having an acoustic impedence of approximately 60 Rayls (a unit of acoustic impendence) or less. In this way, the net acoustic impedence of the acoustically transparent portion of multi-function panel 106 may not exceed approximately 40 Rayls. The acoustically transparent portion of multi-function panel 106 may encompass the entire multi-function panel or some portion thereof. The acoustically transparent portion of multi-function panel 106 may also include a quasi-acoustically transparent material. For this disclosure, a quasi-acoustically transparent material may include those materials that are not entirely acoustically transparent (as defined in this disclosure) but allow for the passage of a sufficient portion of acoustical energy. For example, high-pitched signals (such as those produced by tweeters) do not contain considerable acoustical energy and are, therefore, easily attenuated. Conversely, low-pitched signals (such as those produced by woofers) do contain considerable acoustical energy and are, therefore, not easily attenuated. Accordingly, a multi-function panel 106 through which low-pitched signals pass may be able to possess a higher-level of acoustical impedance (i.e., may be quasi-acoustically transparent) when compared to a multi-function panel 106 through which high-pitched signals pass.

As discussed above, rear projection system 100 may also include an audio system positioned within housing assembly 102. The audio system may include one or more amplifiers 101 within housing assembly 102. The amplifiers may be configured to amplify one or more audio signals supplied by an audio device as is known in the art. The audio signal may be generated in response to activation of a personal media device, AM/FM radio, compact disc player, etc. The output from amplifier 101 may be coupled to speaker system 103 of rear projection system 100 through one or more signal lines 105. The speaker system may include one or more transducers 107 as is known in the art. Some audio speaker transducers may include, but are not limited to, passive radiators, woofers, tweeters, piezoelectric, electrostatic, horn-type, and/or planar magnetic speakers. The audio system may also provide control signals 109 to rear projection device 104. Control signals 109 may include information for inclusion within the graphical user interface (e.g., artist name, track name, album name, date, time, etc).

In some embodiments, rear projection system 100 may include docking port 112 configured to releasably engage an audio device. Examples of such audio devices may include, but are not limited to, digital music players (e.g., MP3 music file players), personal data assistants (PDAs), cellphones, digital cameras, pagers, or any other personal media device. Docking port 112 may include one or more electrical connectors configured to electrically couple the audio device with rear projection system 100. In this way, docking port 112 may be operatively coupled with the audio device and may be configured to receive an audio signal from the audio device and to provide an audio signal for rendering on the speaker system. Docking port 112 may also be configured to receive one or more control signals for transmission to rear projection device 104 and subsequent display via the graphical user interface.

In some embodiments, rear projection system 100 may include an audio signal processor (not shown), which may include various types of circuitries, such as a digital signal processor (DSP). The audio signal processor may perform signal processing on the audio signal generated by the audio device. For example, the audio signal processor may execute any known sound processing algorithms, including but not limited to, sound equalization, digital crossover, bass, treble, volume, surround sound, Dolby Pro-Logic™, AC-3 and MPEG decoding, or other signal processing functions. The digital signal processor may be operatively connected to housing assembly 102 using any number of configurations (e.g. glue, press-fit, etc.).

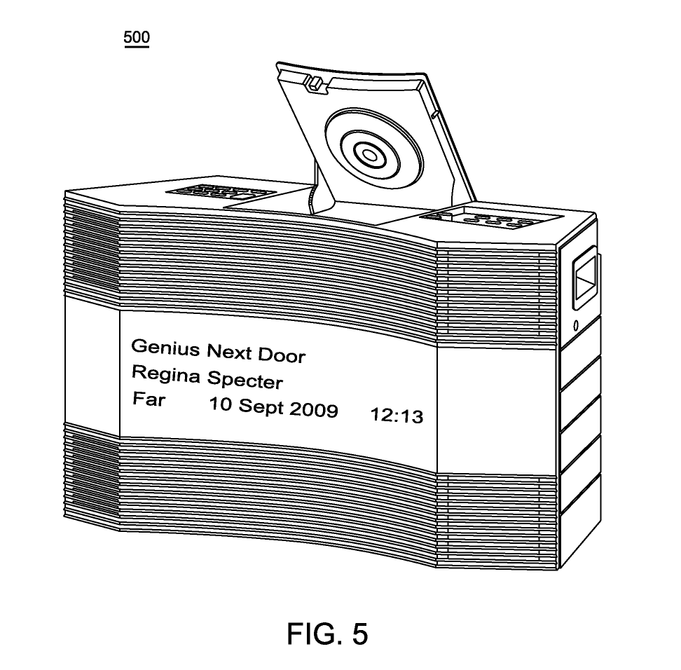

Additionally and/or alternatively, an external tuner/CD player, such as an AM, FM, or satellite tuner, and/or a portable CD player may be associated with rear projection system 100. The external tuner/CD player may be used to play audio signals through the audio system. Other devices, such as minidisk players, cassette players, or digital audio tape (DAT) players may also be used. In one embodiment (FIG. 5), a radio tuner and/or a CD player may be integrated directly into rear projection system 500. External devices may be coupled directly (through a docking port), wired remotely (via a connecting cable), or wirelessly. External devices may provide control signals for transmission to rear projection device 104 and subsequent display via the graphical user interface.

Referring to FIG. 2, a front view of rear projection system 100 is provided. Rear projection system 100 may include housing assembly 102 and rear projection device (not shown). Rear projection system 100 may be configured to display one or more graphical user interfaces (GUIs) 204 via multi-function panel 106 as discussed above. Numerous types of data may be displayed via GUI 204, including, but not limited to, time and/or date information, artist name, album title, track name, status indicator bars, etc. Audio device 208 (e.g., an MP3 player) may be secured within docking port 112. Additionally and/or alternatively, audio device 208 may be configured to communicate wirelessly with rear projection system 100.

In some embodiments, rear projection system 100 may further include remote device 212, which may be configured to communicate in a wired or wireless manner with one or more components of rear projection system 100. For example, remote device 212 may be used to select an audio track from audio device 208. Once the track has been selected, the rear projection device positioned within housing assembly 102 may project graphical user interface 204 onto multi-function panel 106. In this particular example, GUI 204 is displaying the song title “Genius Next Door”, the artist name “Regina Spector”, and the album title “Far”. Numerous other types of information may also be displayed, including but not limited to the clock and date information shown in FIG. 2.

In some embodiments, remote device 212 may be used to control one or more of the properties associated with the GUI displayed. Some of these properties may include, but are not limited to, brightness of the GUI, contrast of the GUI, position of the GUI, information displayed in the GUI, size of the GUI, etc. Some or all of these properties may also be adjusted using a control surface displayed via multi-function panel 106, as is discussed in further detail below.

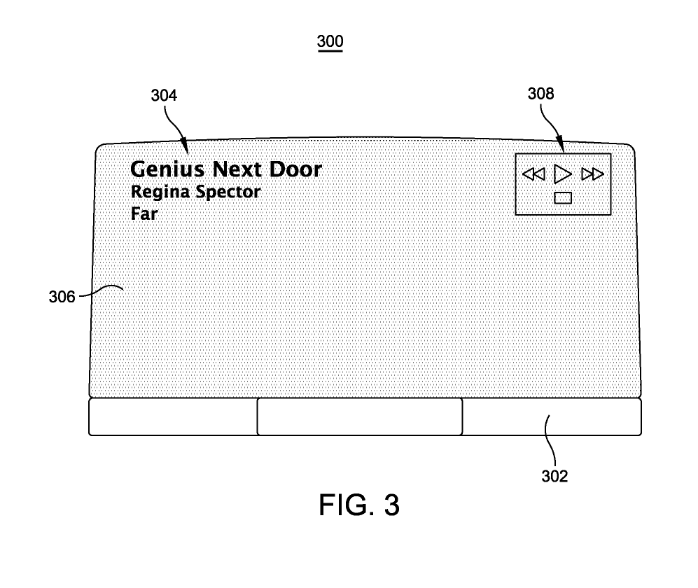

Referring also to FIG. 3, another embodiment of a rear projection system (i.e., rear projection system 300) is provided. Rear projection system 300 may include housing assembly 302 and may be configured to display one or more GUIs 304 via multi-function panel 306. Multi-function panel 306 may include one or more of an acoustically transparent portion and control surface portion 308. For example, multi-function panel 306 may be partially and/or entirely acoustically transparent and may also include control surface portion, which may also be entirely and/or partially acoustically transparent.

In some embodiments, control surface portion 308 may be projected via the rear projection device and may allow a user to select one or more options related to a track that is currently playing, and/or in the selection of additional tracks. For example, in this particular embodiment, control surface portion 308 may allow for the selection of the play, rewind, fast-forward, and/or stop buttons. In this way, control surface portion 308 may be provided on a portion of multi-function panel 306 that may be associated with one or more selectable actuators (e.g., buttons, etc.). In this way, a user may depress the exterior surface of multi-function panel 306 (e.g. the grill, cloth, etc.) in order to depress the actuator associated with a particular selection (e.g. fast-forward). For example, beneath the fast-forward indicator of control surface portion 308 a device, such as a cantilevered diving board type configuration may be present, thus allowing for activation of one or more of the selectable actuators that may be positioned outside of the control surface. In this particular example, upon depressing the portion of multi-function panel 306 beneath the fast forward indicator, a control signal to fast-forward through the song “Genius Next Door” may be received by portions of the audio system and/or audio device (if present). Numerous other selectable mechanisms and technologies (e.g., a transparent touch screen) may be employed without departing from the scope of the present disclosure. The manner in which control surface 308 is configured may be dynamic. For example, a portion of control surface 308 may function as a play button when graphical user interface is displaying a first information screen and may function as a track select button when displaying a second information screen.

In some embodiments, control surface portion 308 may be configured to control numerous additional and/or alternative aspects of rear projection system 300. For example, control surface portion 308 may include additional selectable features, which may allow for updating/altering the time, date displayed, the size and/or properties of the GUI displayed, etc.

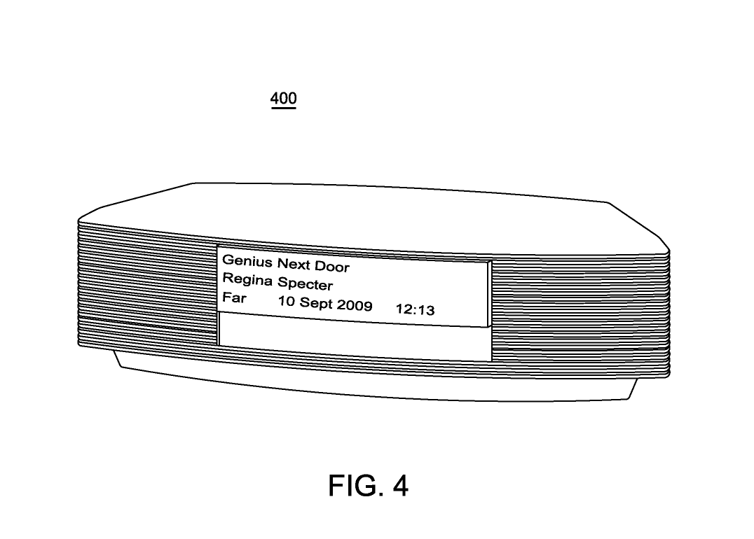

Referring also to FIGS. 4-5, additional embodiments of rear projection systems 400 and 500 are provided. Rear projection systems 400, 500 may include any or all of the components described above with reference to FIGS. 1-3. Rear projection system 400 may be associated with an audio system such as the Wave® music system available from the Bose® Corporation. Similarly, rear projection system 500 may be associated with an audio system such as the Acoustic Wave® music system also available from the Bose® Corporation. The embodiments described herein may allow for the display of a graphical user interface upon curved, non-planar surfaces (as shown in FIGS. 4-5). Numerous other embodiments and configurations are also within the scope of the present disclosure.

As used in any embodiment described herein, the term “circuitry” may comprise, for example, singly or in any combination, digital circuitry, analog circuitry, hardwired circuitry, programmable circuitry, state machine circuitry, and/or firmware that stores instructions executed by programmable circuitry. It should be understood at the outset that any of the operations and/or operative components described in any embodiment herein may be implemented in software, firmware, hardwired circuitry and/or any combination thereof.

As used in any embodiment described herein, the terms “coupled” and “operatively connected”, as used herein, may refer to one or more components that are configured to communicate a signal. The coupled components may be physically connected by electrically conductive wire or by optically transmissive fiber, or may be communicatingly coupled by a wireless technique such as infrared or radio frequency (RF), or other signal communication techniques. Similarly, the term “signal line” as used herein, may refer to any transmissive path, including electrically conductive wire, optically transmissive fiber, a wireless communication path, or other type of signal transmission path, for transmitting analog or digitally encoded signals.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Nevertheless, it will be understood that various modifications may be made. Accordingly, other implementations are within the scope of the following claims.

What is claimed is:

1. A rear projection system comprising:
a housing assembly configured to house at least a portion of a speaker system, the housing assembly including a multi-function panel, wherein the multi-function panel is at least partially optically transmissive and includes an acoustically transparent portion; and
a rear projection device positioned within the housing assembly and configured to project a graphical user interface onto an interior surface of the acoustically transparent portion of the multi-function panel.

2. The rear projection system of claim 1, further comprising:
an audio system positioned within the housing assembly and configured to provide an audio signal for rendering on the speaker system, wherein the audio system provides information for inclusion within the graphical user interface.

3. The rear projection system of claim 1, further comprising:
a docking port configured to releasably engage an audio device and configured to provide an audio signal for rendering on the speaker system, wherein the audio device provides information for inclusion within the graphical user interface.

4. The rear projection system of claim 3, wherein the acoustically transparent portion of the multi-function panel includes a quasi-acoustically transparent material.

5. The rear projection system of claim 1, wherein the multi-function panel includes a control surface portion.

6. The rear projection system of claim 1, wherein the multi-function panel is planar.

7. The rear projection system of claim 1, wherein the multi-function panel is non-planar.

8. The rear projection system of claim 1, wherein the rear projection device is a pico-projector.

9. The rear projection system of claim 8, wherein the pico-projector is a scanned laser pico-projector.

10. The rear projection system of claim 1, further comprising one or more reflective devices positioned within the housing assembly, the one or more reflective devices configured to guide the graphical user interface from the rear projection device to the interior surface of the multi-function panel.

11. The rear projection system of claim 10, wherein at least one of the one or more reflective devices includes a curved minor.

12. A rear projection system comprising:
a housing assembly configured to house at least a portion of a speaker system, the housing assembly including a multi-function panel, wherein the multi-function panel is at least partially optically transmissive and includes an acoustically transparent portion;
a rear projection device positioned within the housing assembly and configured to project a graphical user interface onto an interior surface of the acoustically transparent portion of the multi-function panel; and
an audio system positioned within the housing assembly and configured to provide an audio signal for rendering on the speaker system, wherein the audio system provides information for inclusion within the graphical user interface.

13. The rear projection system of claim 12, wherein the multi-function panel includes a control surface portion.

14. The rear projection system of claim 12, wherein the rear projection device is a pico-projector.

15. The rear projection system of claim 14, wherein the pico-projector is a scanned laser pico-projector.

16. A rear projection system comprising:
a housing assembly configured to house at least a portion of a speaker system, the housing assembly including a multi-function panel, wherein the multi-function panel is at least partially optically transmissive and includes an acoustically transparent portion;
a rear projection device positioned within the housing assembly and configured to project a graphical user interface onto an interior surface of the acoustically transparent portion of the multi-function panel; and
a docking port configured to releasably engage an audio device and configured to provide an audio signal for rendering on the speaker system, wherein the audio device provides information for inclusion within the graphical user interface.

17. The rear projection system of claim 16, wherein the multi-function panel includes a control surface portion.

18. The rear projection system of claim 16, wherein the rear projection device is a pico-projector.

19. The rear projection system of claim 18, wherein the pico-projector is a scanned laser pico-projector.
